(19) United States
(12) Patent Application Publication
(10) Pub. No.: US 2024/0393162 A1
(43) Pub. Date: Nov. 28, 2024

(54) System And Method For Characterizing Surface Geometry And Measuring Large Amplitude Oscillations Using Spatial And Temporal Correlations Of High Frequency Displacement Measurements Made With Diffusively Reflected Light Beams

(71) Applicant: ConcurrentData, Inc., Bringhton, MI (US)

(72) Inventors: Edward J. GILLIS, Ann Arbor, MI (US); Mark RAUCHFUSS, Birmingham, MI (US)

(73) Assignee: ConcurrentData, Inc., Brighton, MI (US)

(21) Appl. No.: 18/663,678

(22) Filed: May 14, 2024

Related U.S. Application Data
(60) Provisional application No. 63/504,595, filed on May 26, 2023.

(51) Int. Cl. G01H 9/00

(52) U.S. Cl. CPC G01H 9/00

(57) ABSTRACT

A non-contact method is presented for measuring vibration on a surface of an object. The method includes: projecting light from one or more light sources towards an area of interest on a surface of an object; detecting the light diffusely reflected by the surface of the object using one or more detectors; determining a change in position of the reflected light detected by the detector over time; for the at least one point on the surface of the object, calculating a series of measurements of vertical displacement of the surface over a period of time from the change in position of the reflected light and using triangulation; and determining frequency of a disturbance of the surface at the at least one point on the surface and an amplitude of the disturbance using the series of measurements of vertical displacement.

### CROSS-REFERENCE TO RELATED APPLICATIONS

This application claims the benefit of U.S. Provisional Application No. 63/504,595, filed on May 26, 2023. The entire disclosure of the above application is incorporated herein by reference.

### FIELD

The present disclosure relates to a non-contact and minimally invasive method for measuring vibration or oscillations on a surface of an object, for example in a frequency range of zero to 50 kilohertz.

### BACKGROUND

Conventional methods of measuring surface oscillations on the surface of an object or structure under test rely upon physically attaching piezoelectric sensors to the surface of the object. There are a number of undesirable effects and dependencies resulting from physical attachment of these sensors onto the surface of the object, which affect the physical and acoustical behavior of the surface, and can result in inaccurate and unreliable observation of surface oscillations. Therefore, it is desirable to develop a non-contact technique for measuring vibrations or oscillations on a surface of an object.

An alternate means for measuring vibrations or oscillations is to illuminate a sufficient number of localized regions with narrow light beams and to determine the spatial and temporal correlations of changes of position of those surface locations relative to an axis that is substantially perpendicular to the surface. These changes in position can be determined by standard triangulation techniques, taking into account the position of the emitter, the location of the illuminated spot on the surface (in a plane that is substantially parallel to the surface), and the position of the detector. However, for this method to work it is essential that the illuminated spots on the surface are visible to the detector. This depends on the angle at which the incident light beam is reflected. If the surface is highly reflective (i.e., specularly reflective) it will reflect the incident light in a very narrow beam (“angle of reflection equals angle of incidence”) at an angle that is sensitively dependent on both the position of the illuminated spots and on the rapidly varying angle of the surface at those locations, making it difficult for the detector to intercept the light beam. Thus, it will fail to detect all but the smallest disturbances propagating across the surface.

This section provides background information related to the present disclosure which is not necessarily prior art.

### SUMMARY

This section provides a general summary of the disclosure, and is not a comprehensive disclosure of its full scope or all of its features.

In one aspect, a non-contact method is presented for measuring vibration on a surface of an object. The method includes: projecting light from one or more light sources towards an area of interest on a surface of an object, where the light projected from the one or more light sources is incident on at least one point on the surface of the object; detecting the light diffusely reflected by the surface of the object using one or more detectors; for each of the one or more detectors, determining, by a processor, a change in position of the reflected light detected by the detector over time, where the processor is interfaced with each of the one or more detectors; for the at least one point on the surface of the object, calculating, by a processor, a series of measurements of vertical displacement of the surface over a period of time from the change in position of the reflected light and using triangulation; and determining frequency of a disturbance of the surface at the at least one point on the surface and an amplitude of the disturbance using the series of measurements of vertical displacement.

In an example embodiment, vertical displacement is calculated according to dz=[(i*s1)−zd′]/[(d′+(i*cotangent(Θ)))], where d′ is distance between where the reflected light is incident on the detector and a reference point on the detector, i is distance between the detector and receiving lens associate therewith, z is length of an altitude of a triangle when the object is not subject to external forces, s1 is a segment of a base of the triangle between the detector and intersection of the altitude, and Θ is angle between the projection axis and a base plane, wherein a line between the light source and the detector lies in the base plane, the base plane is parallel to the surface of the object, and the triangle is formed by the light source, the detector and the point of interest. The equation described above is based on the principles of geometric optics and the exact form of the equation depends on the optical elements and their specific geometric arrangement within the observation device. Variations on this particular arrangement are understood by those skilled in the art of optics, and these variations can lead to modifications and possibly additional terms in the equation. As an example, the detector can be oriented at an angle, Φ, relative to the base plane. In these orientations d′ would be changed to d′/cos Φ. In other variations, additional lenses or mirrors could be used to alter the magnification or for reasons of packaging. The relative distances and angular orientations of these elements determine the exact form of the equation. The essential point is that the principles of geometric optics can be applied and that they result in a deterministic relationship between the motion of the target surface and the movement of the image of the illuminated spot on the detector chip.

In another aspect, the non-contact method for measuring vibration on a surface of an object may employ more than one light source and more than one detector. For example, the method includes: projecting light from two or more light sources towards an area of interest on a surface of an object, where the light projected from the two or more light sources is incident on two or more distinct points on the surface of the object; detecting the light diffusely reflected by the surface of the object using at least one detector; for each of the at least one detector, determining, by a processor, a change in position of the reflected light detected by a given detector over time, where the processor is interfaced with each of the at least one detector; for each of the two or more distinct points on the surface of the object, calculating, by a processor, a series of measurements of vertical displacement of the surface over a period of time from the change in position of the reflected light and using triangulation; and determining a direction of a wave propagating along the surface at the area of interest using the series of measurements of vertical displacement.

For example, light is projected from two light sources and the light diffusely reflected by the surface of the object is detected by one detector. In another example, light is projected from two light sources and the light diffusely reflected by the surface on the object is detected by two detectors, where each detector of the two detectors captures light from a corresponding one of the two light sources.

In some embodiments, the frequency of the wave propagating along the surface is determined by performing a Fourier analysis on the at least three measurements of vertical displacement. Additionally, the speed of the wave propagating along the surface is calculated by determining successive occurrences of vertical displacements having a maximum value and measuring a difference in time between successive occurrences of vertical displacements having a maximum value.

In other embodiments, the projection axis of the light from the one or more light sources is substantially perpendicular to the surface of the object. In this case, the vertical displacement is calculated according to dz=[(i*s1)/d′]−z, where d′ is distance between where the reflected light is incident on the detector and a reference point on the detector, i is distance between the detector and receiving lens associate therewith, z is length of an altitude of a triangle when the object is not subject to external forces, s1 is a segment of a base of the triangle between the detector and intersection of the altitude, and the light beam is oriented substantially perpendicular to the target surface so that the term cot Θ occurring in the equation above is essentially zero and so does not appear, Θ is angle between the projection axis and a base plane, wherein a line between the light source and the detector lies in the base plane, the base plane is parallel to the surface of the object, and the triangle is formed by the light source, the detector and the point of interest. An advantage of projecting the light beam in a substantially perpendicular direction to the target surface is that the illuminated spot remains in the same location on the surface as the surface moves in a vertical direction (i.e., along the z-axis). As described 8 above, additional optical elements and variations in their geometric relationship can lead to modifications in the exact form of the equation. By applying the principles of geometric optics, a deterministic relationship between the motion of the target surface at the location of the illuminated spot and the motion of the image of the illuminated spot on the detector chip is maintained.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating a non-contact technique for measuring vibrations on a surface of an object.

FIG. 2A is a diagram further depicting the parameters for calculating vertical displacement of the surface.

FIG. 2B is a diagram depicting the parameters for calculating vertical displacement of the surface when emitter is directly aligned with the point of interest on the surface of the object.

FIG. 2C is a diagram depicting an arrangement in which the detector chip is rotated at an angle, Φ, from the base plane.

FIGS. 3A and 3B depict an arrangement for multiple emitter-detector pairs from a side view and a top view, respectively.

FIGS. 4A and 4B depicts an alternative arrangement of four emitters with a single detector from a side view and a top view, respectively.

FIG. 5 is a diagram showing a temporal sequence of displacements for a point of interest on a target surface.

FIG. 6 is a diagram showing a temporal sequence of displacement at two points of interest on a target surface.

FIG. 7 is a diagram showing the geometric relationship for calculating angular inclination at a point of interest on the target surface.

FIG. 8 depicts a wave propagating along a surface in relation to an array of observation devices.

Corresponding reference numerals indicate corresponding parts throughout the several views of the drawings.

### DETAILED DESCRIPTION

Example embodiments will now be described more fully with reference to the accompanying drawings. Some terms used throughout this disclosure are defined as follows. Vertical is understood to be the direction that is perpendicular to the principal plane of the target surface; where this direction is also designated as being parallel to the z-axis. The principal plane is defined as the plane that is most closely parallel to the general orientation of the surface. For example, the principal plane of a perfectly flat surface would be the plane in which that surface lies, such that the coordinate axes for the principal plane are labeled ‘x’ and ‘y’. For a base plane, a line between the light source and the detector lies in the base plane and the base plane is parallel to the surface of the object. More specifically, the base plane passes through the lens of the detector.

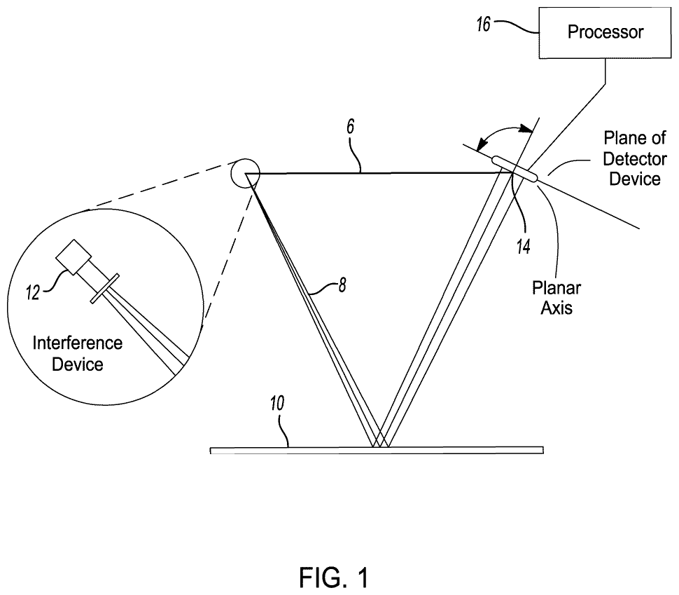

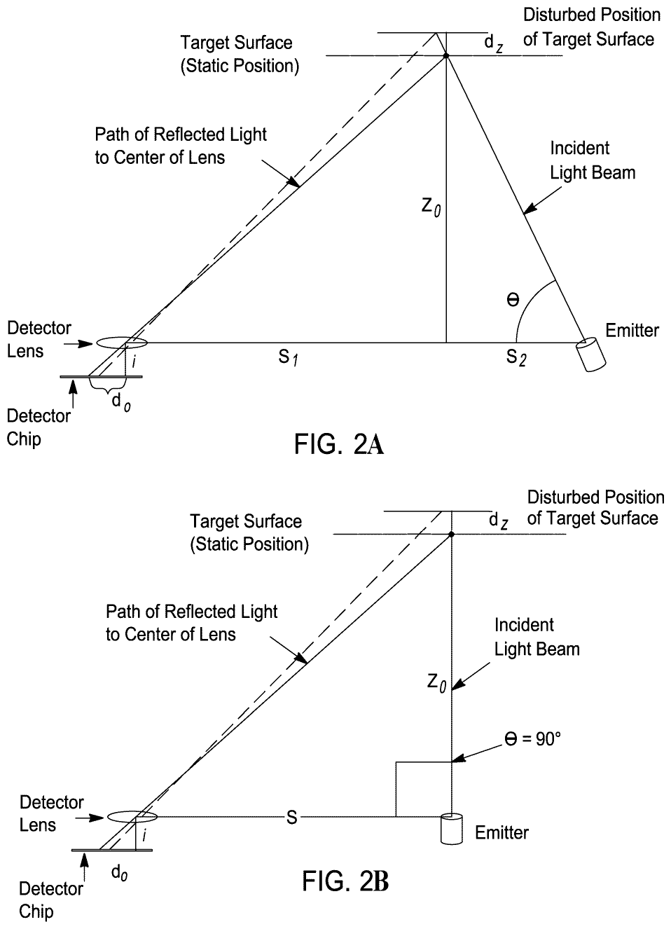

FIGS. 1 and 2A illustrate a non-contact technique for measuring vibrations (or oscillations) on a surface 10 of an object. Light is projected by a light source 12 along a projection axis 8 towards a point of interest on a surface of the object. Light diffusively reflected by the surface is in turn detected by a light detector 14. In one example, the light source is further defined as a laser and the light detector is further defined as a charge-coupled device (CCD). It is readily understood that other types of light detectors, such as CMOS imaging device, also fall with the scope of this disclosure.

In some embodiments, diffusively reflective material is attached to an area on the surface of the object, where the measurement points (or points of interest lie in the area). Examples of diffusively reflective materials include but are not limited to paint of an appropriate color and texture, a decal or an abrasion. Other types of materials also fall within the broader aspects of this disclosure.

To calculate vertical displacement of the surface at the point of interest, the light detector 14 is interfaced with a processor 16. The processor 16 determines a change in position of the reflected light detected by the detector. From the change in position, the vertical displacement of the surface can be calculated using triangulation. More specifically, vertical displacement is calculated according to

$$dz = [ ( i ⋆ s 1 ) - {zd}^{′} ] / [ ( {d}^{′} + i ⋆ contagent ( ⊖ ) ) ) ]$$

where d′ is distance between where the reflected light is incident on the detector and a reference point on the detector, i is distance between the detector and receiving lens associate therewith, z is length of an altitude of a triangle when the object is not subject to external forces, s is distance between the light source and the center of the detector lens (also referred to herein as the baseline), s1 is a segment of a base of the triangle between the detector and the intersection of the altitude with the base, and Θ is angle between the projection axis and a base plane, such that a line between the light source and the detector lies in the base plane, the base plane is parallel to the surface of the object, and the triangle is formed by the light source, the detector and the point of interest on the surface of the object. More specifically, d′ is the distance measured between where the reflected light is incident on the detector and the point on the detector directly aligned with center of the detector lens. As described above, variations in the components of the detector and their orientation imply modifications to the exact form of the equation in accord with the principles of geometric optics, resulting in a deterministic functional relationship between motions of the target surface and movements of the image of the illuminated spot on the detector chip.

In order to report oscillations of the surface, the light detector 14 is configured to capture changes in light position at more than 40,000 frames per second. In an example embodiment, the light detector is clocked at 160,000 frames per second. It is understood that observation at lower frame rates could be used and offer advantages in certain applications. Additionally, at least three measurements are needed to define a waveform indicative of the oscillations. This non-contact approach does not affect the physical and acoustical behavior of the surface of the object. Furthermore, this approach is unsusceptible to high temperatures, high temperature gradient, and exposure to extreme electrostatic and electromagnetic interference.

In one example, the processor 16 is implemented as a microcontroller. It should be understood that the functions performed by the processor can be implemented in hardware logic, software logic, or a combination of hardware and software logic. In this regard, processor 16 can be or can include any of a digital signal processor (DSP), microprocessor, microcontroller, or other programmable device which are programmed with software implementing the above described methods. It should be understood that alternatively the processor is or includes other logic devices, such as a Field Programmable Gate Array (FPGA), a complex programmable logic device (CPLD), or application specific integrated circuit (ASIC). When it is stated that processor 16 performs a function or is configured to perform a function, it should be understood that processor 16 is configured to do so with appropriate logic (such as in software, logic devices, or a combination thereof).

In an alternative arrangement, the emitter is directly aligned with the point of interest on the surface of the object as seen in FIG. 2B. That is, Θ is substantially 90 degrees, such that cotangent (Θ)=substantially zero and s1=s, thereby simplifying the equation for computing vertical displacement. In this arrangement, vertical displacement is calculated according to

$$dz = [ ( i ⋆ s ) / {d}^{′} ] - z$$

where d′ is distance between where the reflected light is incident on the detector and a reference point on the detector, i is distance between the detector and receiving lens associate therewith, s is distance between the light source and the emitter z is length of an altitude of a triangle formed by the light source, the detector and the point of interest on the surface of the object when the surface is not being excited. Other arrangements for aligning the light source and/or the emitter in relation to the object surface are also contemplated by this disclosure. For example, FIG. 2C shows an arrangement in which the detector chip is rotated at an angle, Φ, from the base plane, leading to a modification of the equation with d′ replaced by d′/cos Φ.

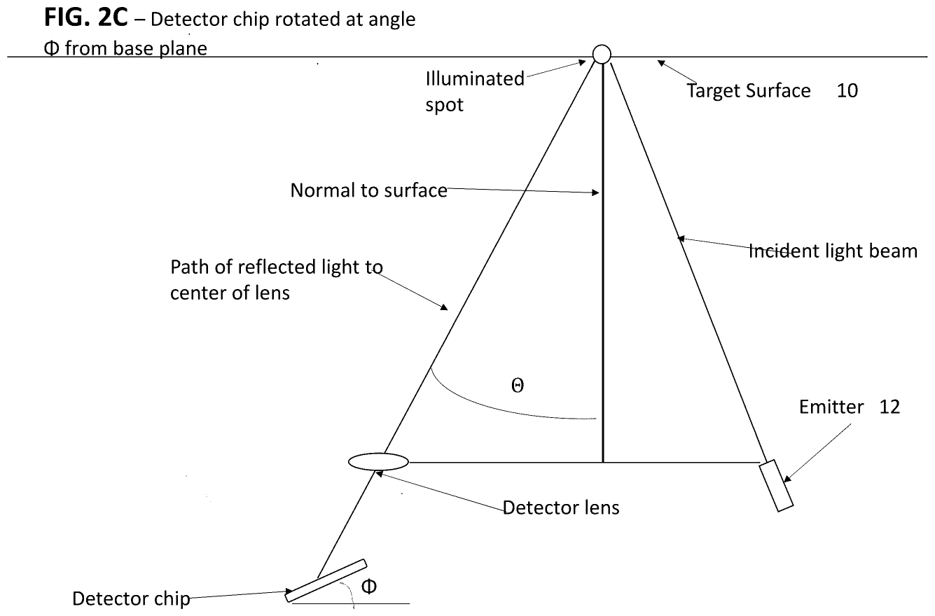

To observe dynamic change in topography of the surface in three degrees of freedom, the non-contact measurement technique preferably includes multiple emitter/detector pairs, for example as seen in FIGS. 3A and 3B. In this arrangement, light is projected from the four light sources towards an area of interest on the surface of the object, such that the light is incident on four distinct points on the surface of the object. Light reflected by the surface is detected using different light detectors, i.e., each light detector captures light from a corresponding one of the light sources. The position of the reflected light incident on the detector is captured by the light detector and changes in position of the reflected light incident on the detector are measured over time. Measurements by each light detector may be triggered concurrently, for example by a reference clock signal. For synchronization, each measurement is tagged with a precise time stamp by the processor. To ensure accurate correspondence between emitter/detector pairs, intensity of the light emitted from the light sources may be modulated with different pre-defined patterns of frequency variation.

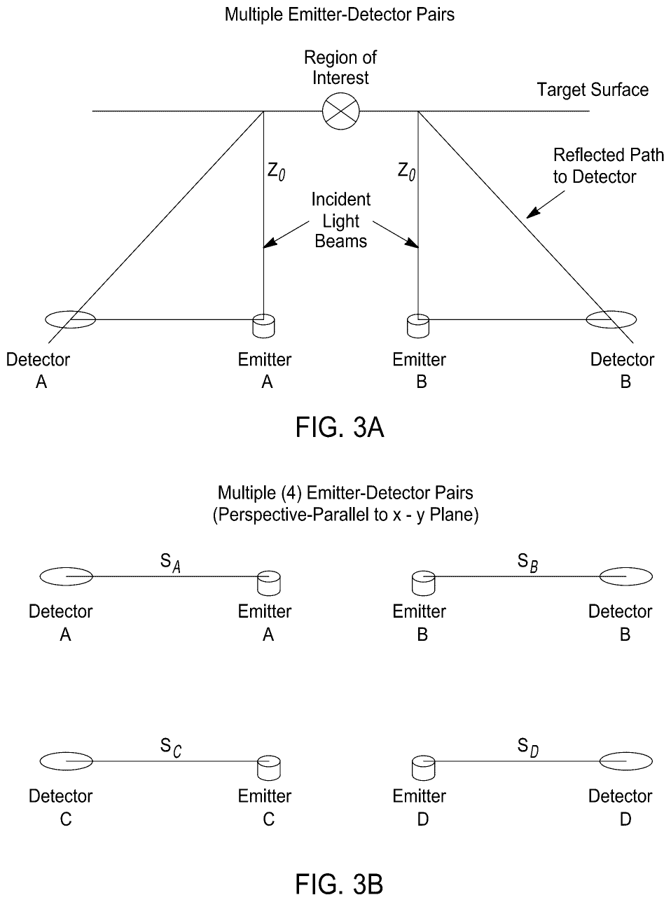

FIGS. 4A and 4B show an alternative arrangement for the non-contact measurement technique. Similarly, light is projected from the four light sources towards an area of interest on the surface of the object, such that the light is incident on four distinct points on the surface of the object. In this arrangement, a single detector is used to capture the light reflected from all four of the light sources. The reflected beams from the different sources would be imaged in different locations on the detector chip. The x and y coordinates of the image for each source, under static conditions would be determined by activating each light source individually prior to the dynamic test, and storing the information for reference. Deviations from these positions under dynamic tests could then be associated with the correct light source tracked. The position of the reflected light incident on the detector is captured by the light detector and changes in position of the reflected light incident on the detector are measured over time.

Displacement of the surface at a given point of interest is indicative of vibrations experienced by the surface of the object. By measuring and computing the displacement values described above over time, one can generate a times series of displacement values and determine a vector representing a wave propagating along the surface of the object at the point of interest.

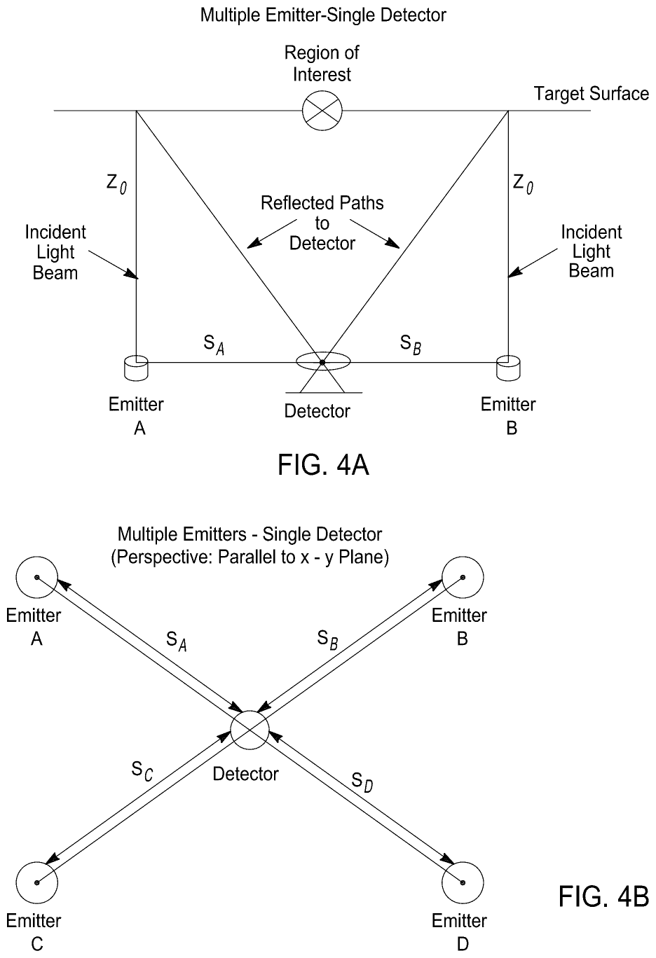

FIG. 5 illustrates one possible temporal sequence of vertical displacements at a single illuminated spot on the target surface which are used to calculate the time period of oscillations. The time period of an oscillation at the observation point can be calculated by recording the difference in the times between the largest positive deviation, +dz, and the largest negative deviation, −dz, and multiplying the difference by two. The determination of maximum positive and negative deviations from an equilibrium position of the surface can be determined through several standard signal processing techniques.

From the displacement measurements, the frequency of oscillations at the observation point can also be calculated by performing a Fourier analysis of the sequence of displacements, dz, over an appropriate interval of time. The appropriate time interval for measuring the sequence of displacement measurements depends on the sampling rate and the anticipated frequency of the oscillations. For illustration purposes, the structure is subjected to external excitations and displacement measurements for each emitter are made at high frequency, for example, 40 kilohertz. From the Nyquist sampling theorem this provides the necessary data to determine all frequencies up to one half the sampling frequency (for example, 20 kilohertz). The relative contributions of the dominant frequencies can be obtained by Fourier analysis. The dominant frequencies determine the specific time intervals over which to look for maximum displacements. For example, a frequency of 2 kilohertz implies time intervals of 500 microseconds (0.5 milliseconds). With a 40 kilohertz sample rate, this corresponds to a set of 20 consecutive measurements from each emitter. In other words, the maximum positive and negative deviations from the equilibrium position are determined from a set of 20 consecutive samples. The “dominant” frequencies are those which contain the greatest amount of energy, where the energy in the signal is determined by the square of the amplitude and the set of dominant frequencies would include those frequencies that that jointly contain a large fraction of the total energy (e.g., 90% of the total energy). All frequencies up to one half of the sampling rate (for example, 44 kilohertz) can be determined in this way through discrete Fourier transforms.

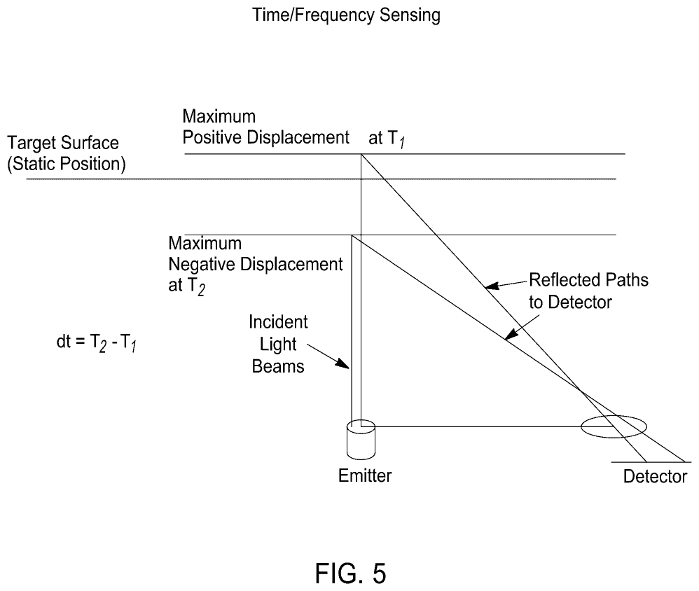

FIG. 6 illustrates a possible temporal sequence of the displacements at two nearby illuminated spots on the target surface which are used to calculate the speed of oscillations along the line joining the two illuminated spots. For illustration purposes, the speed of propagation will be calculated for the arrangement shown in FIG. 3B. In this arrangement, the speed of propagation relative to the x-axis, Vx, is calculated as:

$$Vx = 2 * L / ( [ T ( B ) - T ( A ) ] + [ T ( D ) - T ( C ) ] ) ,$$

and the speed in the y-direction, Vy, is calculated as:

$$Vy = 2 * L ( [ T ( A ) - T ( C ) ] + [ T ( B ) - T ( D ) ] ) ,$$

where Vx and Vy are the speeds in the x and y directions, L is length of the sides of a square formed by the observation points, A, B, C, and D, and T(A), T(B), T(C), and T(D) are the times at which the maximum z-displacements are detected at those observation points. Hence, the total speed of propagation is calculated as sqrt(Vx2+Vy2) and the direction of propagation can be specified as an angle, Δ, as measured in a counterclockwise direction with respect to the x-axis and calculated as: Δ=arctan (Vy/Vx).

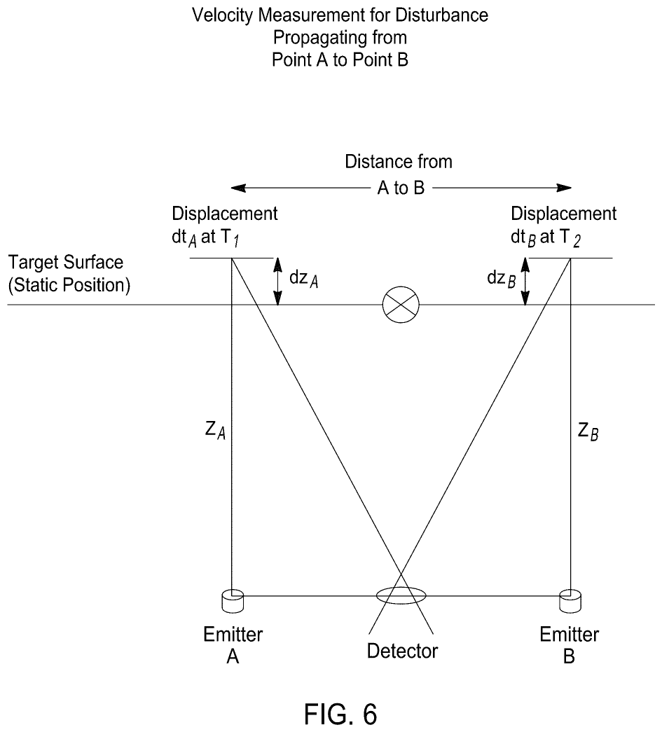

FIG. 7 illustrates the geometric relationships related to the angular inclination of the surface at an observation point. Again, the calculations for the angular inclinations of the surface are for the arrangement shown in FIG. 3B. For the angular inclination of the surface about the x axis, β(x), the angle is calculated according to β(x)=arctan([dz(A)−dz(C)]+[dz(B)−dz(D)])/2*L, and, for the angular inclination of the surface about the y axis, β(y), the angle is calculated according to β(y)=arctan([dz(B)−dz(A)]+[dz(D)−dz(C)])/2*L. These calculations determine the angular deviation from the principal plane of the surface. The calculation of the angular deviation from the initial tangent plane at the point of interest is calculated by subtracting the angular deviation of the initial tangent plane at the point of interest under static conditions. The metrics described above are illustrative of the types of metrics that characterize the propagating wave and that can be derived from the displacement measures. It is envisioned that one or more of these metrics may form a vector that represents the wave propagating along the surface of the object at the point of interest.

Prior to any testing, a 3-dimensional model of the surface could provide an estimate of the signals that would be received at each test location. It could also provide the basis for an algorithm that would predict the variation in the signals in response to various disturbances. Prior to an active test in which various external forces would be applied to the surface, a static survey could be conducted by moving the emitter-detector arrangement in several different ways. The arrangement described above could be moved slowly by some appropriate actuator(s). Small movements toward and away from the target surface, along with movements in the other two dimensions, would enable one to determine the alteration in the signals that would occur with high-frequency disturbances of the surface. Small rotations of the apparatus would provide information about the effect that changes in the angle of the surface would have on the received signals. Essentially, these tests while the surface remains stationary would provide a “slow-motion” version of what to expect during a dynamic test. The information gathered in this way could be compared to the 3-dimensional model, and used to develop (or refine) a tracking algorithm that would predict how the pattern of illumination would move across the detector in response to various disturbances. This algorithm would be used to achieve a sufficiently high sample rate by indicating which subset of pixels should be selected in the next sampling time.

In one aspect of this disclosure, a system may be constructed for measuring vibrations on a surface of an object, where the system is comprised of one or more observation devices. The observation device is supported above the point of interest on the surface of an object by a support mechanism. As noted above, the light sources and the light detectors are housed by the observation device are arranged in a geometric plane that is substantially parallel to the surface of the object. The geometric plane serves as the xy plane of a Cartesian coordinate system; whereas, an imaginary line drawn from the point of interest to the geometric plane serves as the z axis of the Cartesian coordinate system. For calibration purposes, the support mechanism is configured to adjust the position of the observation device in relation to the surface of the object along five degrees of freedom. That is, position of the observation device can be rotated around the x axis, rotated around the y axis or translated along any of the three axis of the Cartesian coordinate system. It is envisioned that the position of the observation device can be adjusted manually by an operator or in an automated manner, for example using servo motors. Suitable support mechanisms are readily found in the art. A graphical interface may be used to assist with positioning of the observation device. The graphical interface operates to display current observed position and orientation of the observation device relative to the point of interest on the surface as well as a priori CAD models of the surface. Observing the graphical interface, an operator can adjust the observation device accordingly.

An example calibration and set-up procedure for an observation device is further described. First, establish the correct vertical (z) and planar (X-Y) orientation of a given observation device in order to aim the focal point of the observation device onto the point of interest on the surface under investigation. To do so, adjust the support mechanism to achieve X and Y orientation of the base plane of the observation device in order that it would be parallel to the X-Y plane (or perpendicular as derived from average of the slopes in the case of observing an acutely peaked at it's zenith) of the surface at the point of interest, for example by manipulating the supporting fixture orientation-adjustment mechanisms. After completing this step, adjust the distance along the vertical z axis between the base plane of the observation device and that of the surface at the point of interest, for example by means of a rack-and-pinion gear-set. Drawing upon the surface topography provided by 3-D renderings, such as CAD, photogrammetric files or high-resolution photographic images, the operator can make judgements for the selection of the desired point of interest on the surface.

To observe and quantify the effect of undesired external (uncontrolled) sources of mechanical excitation acting upon the surface under investigation, one can initiate projection of light from the light sources at a defined level of intensity onto the surface under investigation at the desired point of interest, in order to accurately quantify what, if any acoustic excitation is being conveyed onto the surface by uncontrolled external forces. In the course of this static characterization procedure, the frequency content, amplitude, and velocity of such external excitation is quantified.

To quantify the effect of undesired external (uncontrolled) sources of illumination that may interfere with correct observation by the light detectors, one can initiate projection of light from the light sources at a defined level of intensity onto the surface under investigation. To determine the effects of any stray light at the desired point of interest, compare the detected level of illumination received by each of the light detectors in the observation device by subtracting the level of projected illumination from each of the light sources.

In some embodiments, the system for measuring vibration on a surface of an object is comprised of a plurality of observation devices arranged spatially apart from each other and above the surface of the object. Each observation device is configured to interrogate a different point of interest on the surface of the object.

To coordinate reporting from the plurality of observation devices, each observation device is in data communication (or interfaced) with a central computing device. More specifically, each observation device is configured to receive the same reference clock signal from the central computing device. The reference clock signal serves as a trigger for the light detectors residing in a given observation device to acquire light measurements. Each observation device also includes at least one QR code or another type of unique identifier which can be used to uniquely identify the given observation device in the plurality of observation devices.

Additionally, the position of each observation device in a common coordinate system is also known by the central computing device. For instance, the position of an observation device may be known a prior from CAD data and/or other design documents. Alternatively, the position of each observation device in the common coordinate system may be determined using an independent camera system. Other techniques for determining the position of the observation devices in relation to each other and/or to a common coordinate system are known in the art.

Data from two or more of the observation devices can in turn be used to quantify other metrics related to vibrations experienced by the surface of the object. For example, the speed of a wave propagating between and observed by two observation devices can be computed. Knowing the distance between two observation devices, speed of a propagating wave is determined by dividing this distance by the time it takes the wave to propagate between the two observation devices. This simplified example assumes the wave is propagating along a straight line connecting the two observation devices.

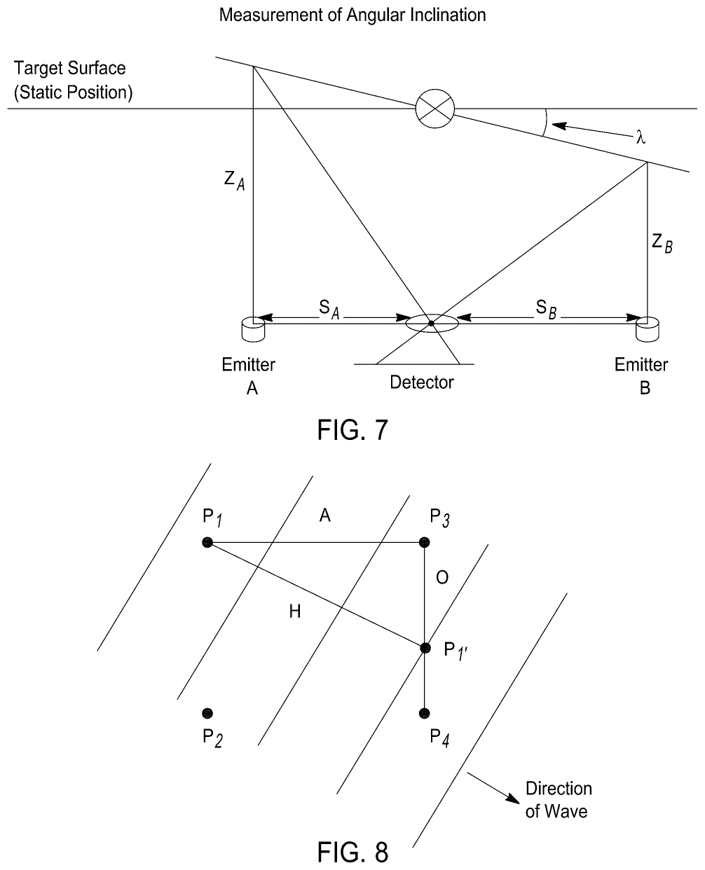

More practically, a wave propagates along a line that passes through one of the observation device P1 but in between two other observation device P3, P4 as seen in FIG. 8. In this case, the wave is traveling in the x-direction. Measure the angle from the x-axis in a counterclockwise sense; this angle can be determined using the direction of wave as computed by observation device P1. The line from P1 to P3 forms the adjacent leg (A) of a right triangle; whereas, the line from P3 that is perpendicular to the adjacent leg, A, to the place where it intersects the x-axis forms the opposite leg (O) of the right triangle; the segment of the x-axis from P1 to the point of intersection forms the hypotenuse (H). There are two different time periods that must be measured. The first of these is the time period between signal peaks at one of the pods. Label this time period as T(freq). It should be the same at both P1 and P3, and it is the inverse of the frequency, f: f=1/T(freq). The second time is the travel time of the wave between P1 and P3. In other words, it is the time between when the peak is observed at P1 and the time that it is observed at P3. Label this time as T(trav). The distance, D, that the wave travels during T(trav) is the distance along the x-axis, i.e., the length of H. The distance along A (from P1 to P3) is known. The angle, theta, has been determined from the directional measurements. The ratio of A to H is the cosine of theta. Therefore the distance, D, along H is A divided by the cosine of theta: H=A/cos(theta). The distance, D, divided by the time period, T(trav), gives the speed of the wave, V: V=D/T(trav). The speed, V, multiplied by the time period associated with the frequency, T(freq), gives the wavelength, lambda: V*T(freq)=lambda.

As noted above, a display device may be interfaced with the processor. During an investigation, a priori CAD or photographical representation of the surface can be displayed on to the display. Metrics related to vibrations experienced by the surface of the object and observed by the system can also be displayed on the display device. In some embodiments, vibrations, including the different propagating waves, experienced by the surface are animated or otherwise visualized (e.g., using a waterfall illustration) on a graphical user interface.

The computational and measurement techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-contact method for measuring vibration on a surface of an object, comprising:
projecting light from one or more light sources towards an area of interest on a surface of an object, where the light projected from the one or more light sources is incident on at least one point on the surface of the object;
detecting the light diffusely reflected by the surface of the object using one or more detectors;
for each of the one or more detectors, determining, by a processor, a change in position of the reflected light detected by the detector over time, where the processor is interfaced with each of the one or more detectors;
for the at least one point on the surface of the object, calculating, by a processor, a series of measurements of vertical displacement of the surface over a period of time from the change in position of the reflected light and using triangulation; and
determining frequency of a disturbance of the surface at the at least one point on the surface and an amplitude of the disturbance using the series of measurements of vertical displacement.

2. The non-contact method of claim 1 wherein vertical displacement is calculated according to
$$dz = [ ( i ⋆ s 1 ) - {zd}^{′} ] / [ ( {d}^{′} + i ⋆ contagent ( ⊖ ) ) ) ]$$
where d′ is distance between where the reflected light is incident on the detector and a reference point on the detector, i is distance between the detector and receiving lens associate therewith, z is length of an altitude of a triangle when the object is not subject to external forces, s1 is a segment of a base of the triangle between the detector and intersection of the altitude, and Θ is angle between the projection axis and a base plane, wherein a line between the light source and the detector lies in the base plane, the base plane is parallel to the surface of the object, and the triangle is formed by the light source, the detector and the point of interest.

3. The non-contact method of claim 1 further comprises determining frequency of a wave propagating along the surface by performing a Fourier analysis on the series of measurements of vertical displacement.

4. The non-contact method of claim 1 further comprises calculating speed of a wave propagating along the surface by determining successive occurrences of vertical displacements having a maximum value in the series of measurements and measuring a difference in time between successive occurrences of vertical displacements having a maximum value.

5. The non-contact method of claim 1 wherein the light source is further defined as a laser and the detector is further defined as a charge-coupled device.

6. The non-contact method of claim 1 wherein the one or more detectors detect light reflected by the surface at more than 40,000 frames per second.

7. The non-contact method of claim 1 further comprises attaching diffusively reflective material to an area on the surface of the object.

8. A non-contact method for measuring vibration on a surface of an object, comprising:
projecting light from two or more light sources towards an area of interest on a surface of an object, where the light projected from the two or more light sources is incident on two or more distinct points on the surface of the object;
detecting the light diffusely reflected by the surface of the object using at least one detector;
for each of the at least one detector, determining, by a processor, a change in position of the reflected light detected by a given detector over time, where the processor is interfaced with each of the at least one detector;
for each of the two or more distinct points on the surface of the object, calculating, by a processor, a series of measurements of vertical displacement of the surface over a period of time from the change in position of the reflected light and using triangulation; and
determining a direction of a wave propagating along the surface at the area of interest using the series of measurements of vertical displacement.

9. The non-contact method of claim 8 further comprises determining frequency of the wave propagating along the surface by performing a Fourier analysis on the at least three measurements of vertical displacement.

10. The non-contact method of claim 8 further comprises calculating speed of the wave propagating along the surface by determining successive occurrences of vertical displacements having a maximum value and measuring a difference in time between successive occurrences of vertical displacements having a maximum value.

11. The non-contact method of claim 8 wherein the light source is further defined as a laser and the detector is further defined as a charge-coupled or device.

12. The non-contact method of claim 8 wherein each of the at least one detector detects light reflected by the surface at more than 40,000 frames per second.

13. The non-contact method of claim 8 wherein the light is projected from two light sources and the light diffusely reflected by the surface of the object is detected by one detector.

14. The non-contact method of claim 8 wherein light is projected from two light sources and the light diffusely reflected by the surface on the object is detected by two detectors, where each detector of the two detectors captures light from a corresponding one of the two light sources.

15. A non-contact method for measuring vibration on a surface of an object, comprising:
projecting light from one or more light sources towards an area of interest on a surface of an object, where the light projected from the one or more light sources is incident on at least one point on the surface of the object and the projection axis of the light from the one or more light sources is perpendicular to the surface of the object;
detecting the light diffusely reflected by the surface of the object using one or more detectors;
for each of the one or more detectors, determining, by a processor, a change in position of the reflected light detected by the detector over time, where the processor is interfaced with each of the one or more detectors;
for the at least one point on the surface of the object, calculating, by a processor, a series of measurements of vertical displacement of the surface over a period of time from the change in position of the reflected light and using triangulation; and
determining frequency of a disturbance of the surface at the at least one point on the surface and an amplitude of the disturbance using the series of measurements of vertical displacement.

16. The non-contact method of claim 15 wherein vertical displacement is calculated according to
$$dz = [ ( i ⋆ s ) / {d}^{′} ] - z$$
where d′ is distance between where the reflected light is incident on the detector and a reference point on the detector, i is distance between the detector and receiving lens associate therewith, z is length of an altitude of a triangle when the object is not subject to external forces, s1 is a segment of a base of the triangle between the detector and intersection of the altitude, and Θ is angle between the projection axis and a base plane, wherein a line between the light source and the detector lies in the base plane, the base plane is parallel to the surface of the object, and the triangle is formed by the light source, the detector and the point of interest.

17. The non-contact method of claim 1 further comprises determining frequency of a wave propagating along the surface by performing a Fourier analysis on the series of measurements of vertical displacement.

18. The non-contact method of claim 1 further comprises calculating speed of a wave propagating along the surface by determining successive occurrences of vertical displacements having a maximum value in the series of measurements and measuring a difference in time between successive occurrences of vertical displacements having a maximum value.

19. The non-contacting method of claim 1 further comprises displaying the surface of the object on a display device and superimposing metrics describing the disturbance of the surface onto the display device.

20. The non-contacting method of claim 19 further comprises animating the disturbance of the surface on the display device.
